(19) United States
(12) Patent Application Publication
(10) Pub. No.: US 2013/0261784 A1
(43) Pub. Date: Oct. 3, 2013

(54) WAFER PROCESSING METHOD AND WAFER PROCESSING SYSTEM

(71) Applicant: Seiji FUJIOKA, Fukuoka (JP)

(72) Inventor: Seiji FUJIOKA, Fukuoka (JP)

(21) Appl. No.: 13/733,785

(22) Filed: Jan. 3, 2013

(30) Foreign Application Priority Data
Mar. 29, 2012 (JP) 2012-077084

(51) Int. Cl. G06F 17/50

(52) U.S. Cl. CPC G06F 17/50
USPC 700/121

(57) ABSTRACT

A method of processing a wafer, includes processing a first type wafer and a second type wafer, inspecting the wafers, deriving a first relational expression from a parameter that depends on the type of wafer and from inspection results, the first relational expression relating the inspection results to the parameter, calculating a next processing condition for next wafer type to be processed from the first relational expression, processing a wafer under the next processing condition, inspecting the wafer, producing a second relational expression by correcting the first relational expression using reference points determined in accordance with the first relational expression and a point representing the inspection result of the wafer, and processing wafers under a processing condition calculated from the second relational expression.

### BACKGROUND OF THE INVENTION

1. Field of the Invention

The present invention relates to a method and system for processing a wafer.

2. Background Art

Japanese Laid-Open Patent Publication No. 2009-152269 discloses a method wherein processing conditions for a wafer are determined by first performing a simulation and then correcting the simulation results using measured data.

Wafer processing apparatus processes various types of wafers. Therefore, in order to perform the desired processing of each wafer, the apparatus preferably sets different processing conditions for different types of wafers. The technique disclosed in the above-cited publication, however, is disadvantageous in that it is necessary to perform a simulation for determining wafer processing conditions, which requires complicated computation.

### SUMMARY OF THE INVENTION

The present invention has been made to solve the foregoing problem. It is, therefore, an object of the present invention to provide a wafer processing method and a wafer processing system wherein the optimum processing conditions for each type of wafer can be determined by using a simple method.

The features and advantages of the present invention may be summarized as follows.

According to one aspect of the present invention, a method of processing a wafer, includes a first processing step wherein a processing apparatus applies predetermined processing to a first type wafer and a second type wafer, a first inspection step wherein an inspection apparatus inspects the wafers after the wafers have been processed in the first processing step, a step wherein an inspection result acquisition section obtains inspection results of the first inspection step, a step wherein a relational expression determination section derives a first relational expression from a parameter that depends on the type of wafer and from the inspection results, the first relational expression relating the inspection results to the parameter, a step wherein a next wafer type identification section identifies a next wafer type to be processed by the processing apparatus, a step wherein a next processing condition calculation section calculates a next processing condition from the first relational expression, the next processing condition being for the next wafer type to be processed, a step wherein a notification section notifies the processing apparatus of the next processing condition, a second processing step wherein the processing apparatus processes a wafer under the next processing condition, a second inspection step wherein the inspection apparatus inspects the wafer after the wafer has been processed in the second processing step, a step wherein the inspection result acquisition section obtains an inspection result of the second inspection step, a step wherein the relational expression determination section produces a second relational expression by correcting the first relational expression using reference points determined in accordance with the first relational expression and a point representing the inspection result of the second inspection step, the reference points and the point being set on a coordinate plane whose horizontal axis represents the parameter and whose vertical axis represents the inspection results, and a step wherein a wafer is processed under a processing condition calculated from the second relational expression. Each time the inspection apparatus produces a new inspection result, the last relational expression is corrected using reference points which are determined in accordance with the last relational expression and a point which represents the new inspection result.

According to another aspect of the present invention, a wafer processing system includes a processing apparatus for applying predetermined processing to a first type wafer and a second type wafer, an inspection apparatus for inspecting the wafers after the wafers have been processed by the processing apparatus, an inspection result acquisition section for obtaining inspection results produced by the inspection apparatus, a relational expression determination section for deriving a first relational expression from a parameter that depends on the type of wafer and from the inspection results, the first relational expression relating the inspection results to the parameter, a next wafer type identification section for identifying a next wafer type to be processed by the processing apparatus, a next processing condition calculation section for calculating a next processing condition from the first relational expression, the next processing condition being for the next wafer type to be processed, and a notification section for notifying the processing apparatus of the next processing condition. The processing apparatus processes a wafer under the next processing condition. The inspection apparatus inspects the wafer after the wafer has been processed under the next processing condition. The inspection result acquisition section obtains an inspection result of the wafer inspected after the wafer has been processed under the next processing condition. The relational expression determination section produces a second relational expression by correcting the first relational expression using reference points determined in accordance with the first relational expression and a point representing the inspection result of the wafer inspected after the wafer has been processed under the next processing condition, the reference points and the point being set on a coordinate plane whose horizontal axis represents the parameter and whose vertical axis represents the inspection results. The processing apparatus processes a wafer under a processing condition calculated from the second relational expression. Each time the inspection apparatus produces a new inspection result, the relational expression determination section corrects the last relational expression using reference points which are determined in accordance with the last relational expression and a point which represents the new inspection result.

Other and further objects, features and advantages of the invention will appear more fully from the following description.

### BRIEF DESCRIPTION OF THE DRAWINGS

FIG. 1 is a diagram showing a wafer processing system in accordance with an embodiment of the present invention;

FIG. 2 is a flowchart showing the wafer processing method of the present embodiment;

FIG. 3 is a graph illustrating the first relational expression, which is represented by a straight line in the graph;

FIG. 4 shows the way in which the second relational expression is derived;

FIG. 5 is a diagram showing the way in which the third relational expression is derived;

FIG. 6 is a diagram showing the way in which the i-th relational expression is derived;

FIG. 7 is a diagram showing a straight line representing a comparative relational expression derived only from the last inspection results of a plurality of types of wafers;

FIG. 8 is a diagram showing the way in which a relational expression is corrected using the last inspection result of a type of wafer having a high mask pattern exposed area ratio; and

FIG. 9 is a diagram showing the way in which a relational expression is corrected using the last inspection result of a type of wafer having a low mask pattern exposed area ratio.

### DETAILED DESCRIPTION OF THE PREFERRED EMBODIMENT

### Embodiment

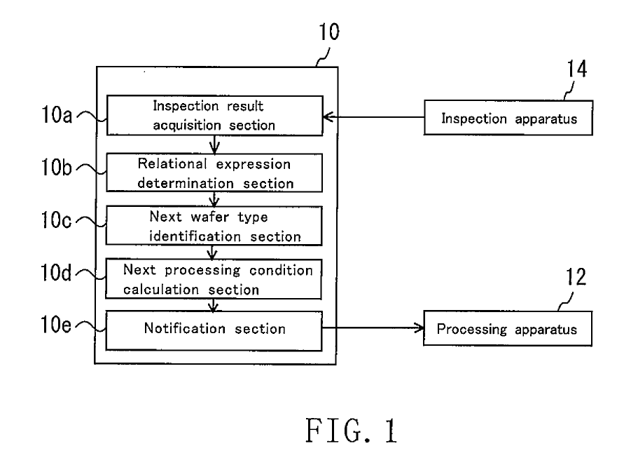

FIG. 1 is a diagram showing a wafer processing system in accordance with an embodiment of the present invention. The wafer processing system includes a computer 10. A processing apparatus 12 and an inspection apparatus 14 are connected to the computer 10. The processing apparatus 12 is an etching apparatus that etches a wafer under conditions which are notified to the processing apparatus 12 by the computer 10. The inspection apparatus 14 inspects the wafer which has been processed by the processing apparatus 12. Further in the wafer processing system of the first embodiment, the computer 10 determines a processing condition for the next wafer to be processed based on an inspection result produced by the inspection apparatus 14 and notifies the processing apparatus 12 of the determined processing condition.

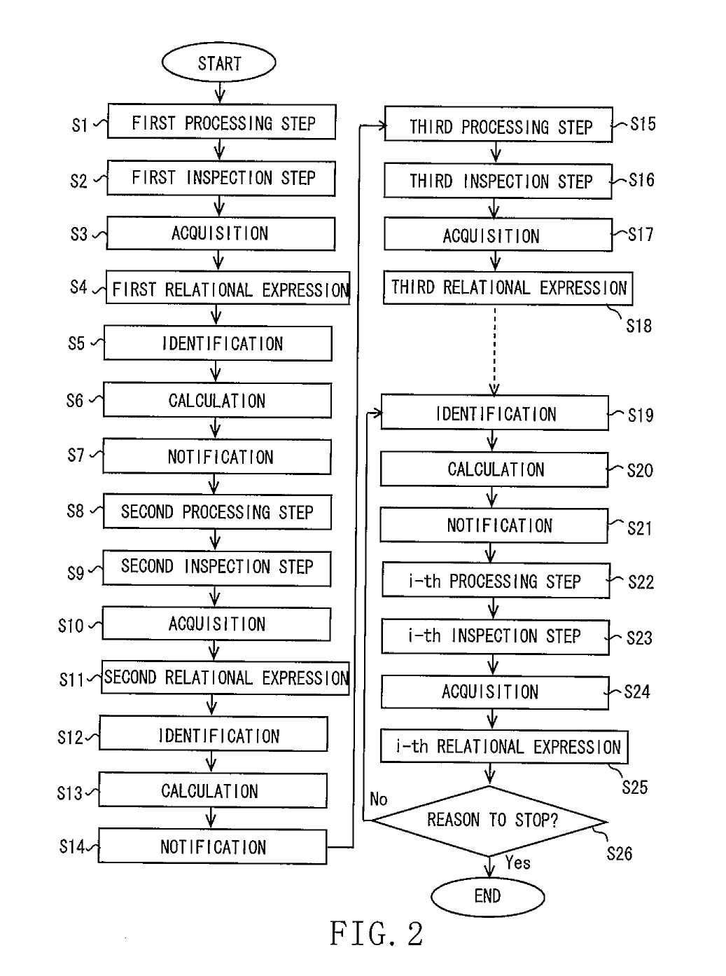

The following description will be directed to a wafer processing method using the wafer processing system in accordance with the present embodiment. FIG. 2 is a flowchart showing the wafer processing method of the present embodiment. The method begins when the processing apparatus 12 etches a first type wafer and a second type wafer. The first type and second type wafers have mask patterns formed thereon. The first type and second type wafers are etched using these mask patterns as masks to form deep trenches therein. The exposed area ratio of the mask pattern on the first type wafer (referred to herein as the first exposed area ratio) is smaller than the exposed area ratio of the mask pattern on the second type wafer (referred to herein as the second exposed area ratio). The greater the difference between the first and second exposed area ratios, the better. This step is referred to herein as the first processing step (step S1). The wafers are transferred to the inspection apparatus 14 after the completion of the first processing step.

After the completion of step S1, the process proceeds to step S2. In step S2, the inspection apparatus 14 inspects the wafers which have been processed in the first processing step. This step is referred to herein as the first inspection step (step S2). In the first inspection step, the inspection apparatus 14 determines the etching rate of the first type wafer and the etching rate of the second type wafer. After the completion of step S2, the process proceeds to step S3. In step S3, an inspection result acquisition section 10a of the computer 10 obtains inspection results of these wafers. This step is referred to herein as the inspection result acquisition step. The inspection result acquisition section 10a obtains the inspection results and associates them with the mask pattern exposed area ratios of the first type and second type wafers. That is, the inspection result acquisition section 10a obtains the etching rates of these wafers and associates these etch rates with the mask pattern exposed area ratios of the wafers. It should be noted that the mask pattern exposed area ratio of each wafer is a parameter determined by its type.

After the completion of step S3, the process proceeds to step S4. In step S4, a relational expression determination section 10b of the computer 10 calculates and derives a first relational expression from the data obtained by the inspection result acquisition section 10a. The first relational expression relates inspection results of the wafers to a parameter that depends on the type of wafer. In accordance with the present embodiment, this parameter is selected to be the mask pattern exposed area ratio of each wafer, and the inspection results indicate the etching rate (another parameter) of each wafer. In the case of etching of a semiconductor, the etching rate may vary with the mask pattern exposed area ratio. For example, the etching rate may tend to increase with decreasing mask pattern exposed area ratio. Since the inspection result acquisition section 10a obtains the inspection results (or etching rates) of the wafers and associates these results with the mask pattern exposed area ratios of the wafers, the first relational expression can be derived from the mask pattern exposed area ratios E and the etching rates V of the wafers.

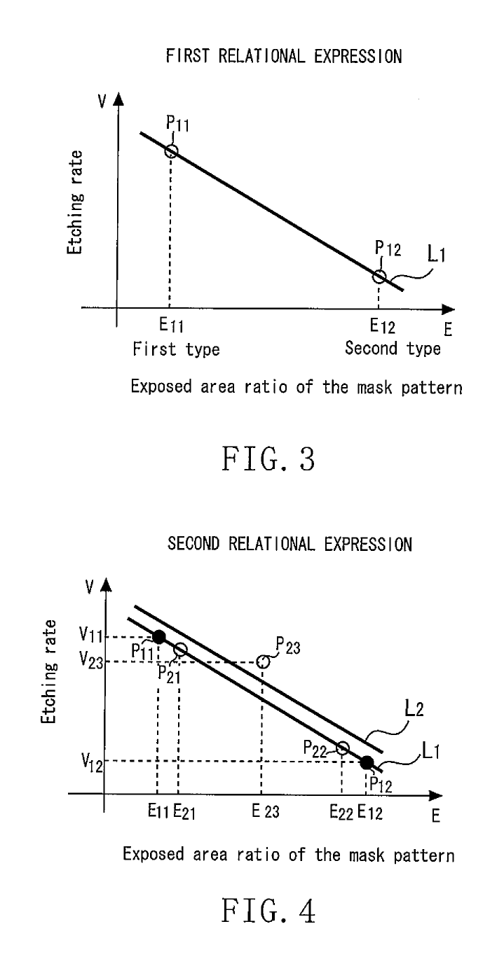

FIG. 3 is a graph illustrating the first relational expression thus obtained, which is represented by a straight line in the graph. The x-axis (or horizontal axis) of this graph represents the mask pattern exposed area ratio E of a wafer, and the y-axis (or vertical axis) represents the etching rate V of the wafer. The line representing the first relational expression passes through a point P₁₁ which indicates the first exposed area ratio E₁₁ and the etching rate of the first type wafer, and a point P₁₂ which indicates the second exposed area ratio E₁₂ and the etching rate of the second type wafer. The first relational expression (or equation) is as follows:

V=V₁(E)=c₁+a₁×E Equation 1

where V is the etching rate, c₁ is the y-intersect of the line, a₁ is the slope of the line, and E is the mask pattern exposed area ratio. That is, the etching rate V is a linear function of the mask pattern exposed area ratio E. This linear function (the first relational expression) is denoted herein by V₁(E). Thus, the first relational expression quantitatively relates the etching rate of a wafer to its mask pattern exposed area ratio. (As described above, the mask pattern exposed area ratio of each wafer is determined by the type of the wafer.) Therefore, this relation expression can be used to compensate for the differences in etching rate between different types of wafers which have different mask pattern exposed area ratios by adjusting the etching conditions. As can be seen from FIG. 3, the greater the difference between the first exposed area ratio E₁₁ and the second exposed area ratio E₁₂ is, the more accurately the first relational expression represents the etching rates of different types of wafers. It should be noted that in order to increase the difference between the first exposed area ratio E₁₁ and the second exposed area ratio E₁₂, the first type and second type wafers processed in the first processing step may be evaluation wafers having thereon mask patterns different from those used for manufacture of the devices.

After the completion of step S4, the process proceeds to step S5. In step S5, a next wafer type identification section 10c identifies the type of the next wafer to be processed by the processing apparatus 12. (This wafer type is referred to herein as the next wafer type to be processed.) After the completion of step S5, the process proceeds to step S6. In step S6, by using the first relational expression, a next processing condition calculation section 10d calculates a processing condition for the next wafer type to be processed. (This processing condition is referred to herein as a next processing condition.) Specifically, the next processing condition calculation section 10d calculates the etching rate V_{calc23} of the next wafer type to be processed by substituting the mask pattern exposed area ratio E₂₃ of the next wafer type to be processed into the first relational expression (that is, calculates the expression c₁+a₁×E₂₃). The next processing condition calculation section 10d then determines an etching condition (i.e., a next processing condition) under which the desired deep trenches can be formed in the wafer at the etching rate V_{calc23}. This etching condition may be the etching duration. That is, for example, the etching duration may be set to be inversely proportional to the etching rate so as to compensate for the differences in mask pattern exposed area ratio (and hence in etching rate) between different types of wafers, making it possible to accurately etch a wafer to the desired depth, regardless of its type.

After the completion of step S6, the process proceeds to step S7. In step S7, a notification section 10e notifies the processing apparatus 12 of the determined next processing condition. After the completion of step S7, the process proceeds to step S8. In step S8, the processing apparatus 12 etches a wafer of the next wafer type to be processed under the next processing condition. This step is referred to herein as the second processing step. After the completion of step S8, the process proceeds to step S9. In step S9, the inspection apparatus 14 inspects the wafer which has been processed in the second processing step. This step is referred to herein as the second inspection step. Further, the inspection results obtained in the most recent inspection are referred to herein as the last inspection results. The last inspection results may be inspection results of one or more types of wafers. After the completion of step S9, the process proceeds to step S10. In step S10, the inspection result acquisition section 10a obtains the last inspection results.

After the completion of step S10, the process proceeds to step S11. In step S11, the relational expression determination section 10b produces a second relational expression by correcting the first relational expression based on the last inspection result in addition to the inspection results of the wafers processed in the first processing step. This correction of the first relational expression (thereby producing the second relation expression) will be described with reference to FIG. 4. FIG. 4 shows the way in which the second relational expression is derived. The original first relational expression is represented by a straight line L₁ in FIG. 4. The second relational expression is represented by a straight line L₂. The line L₁ is derived from the points P₁₁ and P₁₂. The coordinates of P₁₁ and P₁₂ are (E₁₁, V₁₁) and (E₁₂, V₁₂), respectively. The first relational expression is corrected using three points, namely, P₂₁, P₂₂, and P₂₃, thereby producing a new relational expression (i.e., the second relational expression). The points P₂₁ and P₂₂ are reference points on the line L₁. The coordinates of P₂₁ and P₂₂ are (E₂₁, V₁(E₂₁)) and (E₂₂, V₁(E₂₂)), respectively. The point P₂₃ represents the last inspection result, i.e., the mask pattern exposed area ratio E₂₃ and the etching rate V₂₃ of the wafer (of the wafer type to be processed) processed in the second processing step. Therefore, the coordinates of P₂₃ are (E₂₃, V₂₃). The y-intersect and the slope of the second relational expression (which is assumed to be a linear function) are derived from these three points by the least squares method.

Since the coordinates of the three points P₂₁, P₂₂, and P₂₃ are (E₂₁, V₂₁), (E₂₂, V₂₂), and (E₂₃, V₂₃), respectively, the y-intersect c₂ of the second relational expression is represented by the following equation, which is derived by the least squares method:

$${c}_{2} = \frac{{\sum }_{j = 1}^{3} {E}_{2 j}^{2} {\sum }_{j = 1}^{3} {V}_{2 j} - {\sum }_{j = 1}^{3} {E}_{2 j} {V}_{2 j} {\sum }_{j = 1}^{3} {E}_{j}}{3 {\sum }_{j = 1}^{3} {E}_{2 j}^{2} - {( {\sum }_{j = 1}^{3} {E}_{2 j} )}^{2}} \qquad Equation 2$$

Further, the slope a₂ of the second relational expression is represented by the following equation.

$${a}_{2} = \frac{3 {\sum }_{j = 1}^{3} {E}_{2 j} {V}_{2 j} - {\sum }_{j = 1}^{3} {E}_{2 j} {\sum }_{j = 1}^{3} {V}_{2 j}}{3 {\sum }_{j = 1}^{3} {E}_{2 j}^{2} - {( {\sum }_{j = 1}^{3} {E}_{2 j} )}^{2}} \qquad Equation 3$$

The second relational expression is as follows:

V=V₂(E)=c₂+a₂×E Equation 4

Thus, the relational expression determination section 10b produces the second relational expression L₂ by correcting the first relational expression L₁ using the reference points P₂₁ and P₂₂, which are determined in accordance with the first relational expression L₁, and the point P₂₃, which represents the inspection result of the second inspection step, wherein these points are set on a coordinate plane whose x-axis (or horizontal axis) represents the mask pattern exposed area ratio (a parameter) of a wafer and the y-axis (or vertical axis) represents the etching rate (another parameter or inspection result) of the wafer.

If the first exposed area ratio E₂₁ and the second exposed area ratio E₂₂ for deriving the second relational expression are selected to be equal to the first exposed area ratio E₁₁ and the second exposed area ratio E₁₂, respectively, in the first processing step, then the reference points P₂₁ and P₂₂ coincide with P₁₁ and P₁₂, respectively. It should be noted that if E₂₁ and E₂₂ are selected to differ from E₁₁ and E₁₂, then the reference points P₂₁ and P₂₂ do not coincide with P₁₁ and P₁₂ even though these reference points P₂₁ and P₂₂ are on the line L₁. It should be further noted that the greater the difference between the first exposed area ratio E₂₁ and the second exposed area ratio E₂₂ for deriving the second relational expression, the better.

After the completion of step S11, the process proceeds to step S12. In step S12, the next wafer type to be processed (i.e., the wafer type to be processed in the third processing step) is identified. Then, in step S13, a next processing condition (i.e., a processing condition in the third processing step) is calculated from the second relational expression. Specifically, the etching rate V_{calc33} of the next wafer type to be processed is calculated by substituting the mask pattern exposed area ratio E₃₃ of the next wafer type to be processed into the second relational expression (i.e., V₂(E₃₃)), and then an etching condition (i.e., a next processing condition) is determined. Then, in step S14, the notification section 10e notifies the processing apparatus 12 of the determined next processing condition. Then, in step S15 (or the third processing step), the processing apparatus 12 etches a wafer of the next wafer type to be processed under the next processing condition. Then, in step S16 (or the third inspection step), the inspection apparatus 14 inspects the wafer which has been processed in the third processing step. Then, in step S17, the inspection result acquisition section 10a acquires a new inspection result, i.e., the inspection result of the third inspection step.

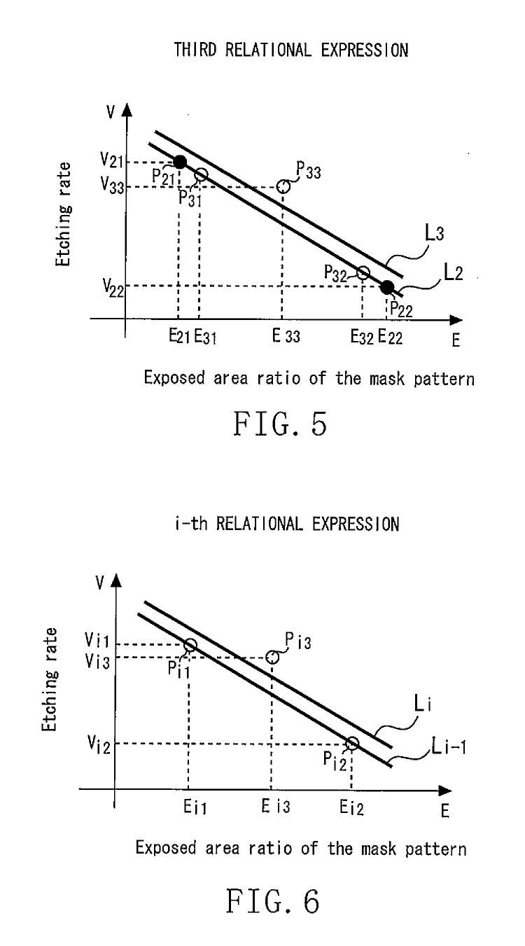

Then, in step S18 (or the third relational expression determination step), the relational expression determination section 10b derives a third relational expression from reference points which are determined in accordance with the second relational expression and from the inspection result which indicates the etching rate in the third processing step. FIG. 5 is a diagram showing the way in which the third relational expression is derived. Specifically, the third relational expression is derived in the following manner. The third relational expression is assumed to be a linear function, and the y-intersect and the slope of a straight line L₃ representing the third relational expression are derived from reference points P₃₁ and P₃₂ on the line L₂ and a point P₃₃ representing the last inspection result, by means of the least squares method. The coordinates of P₃₁ and P₃₂ are (E₃₁, V₂(E₃₁)) and (E₃₂, V₂(E₃₂)), respectively, where E₃₁ and E₃₂ represent first and second mask pattern exposed area ratios, respectively, for deriving the third relational expression. The coordinates of the point P₃₃ are (E₃₃, V₃₃), where E₃₃ represents the mask pattern exposed area ratio of the wafer type processed in the third processing step, and V₃₃ represents the inspection result of third inspection step (i.e., the etching rate in the third processing step). If the first exposed area ratio E₃₁ and the second exposed area ratio E₃₂ for deriving the third relational expression are selected to be equal to the first exposed area ratio E₂₁ and the second exposed area ratio E₂₂, respectively, for deriving the second relational expression, then it is easy to derive the third relational expression. The first exposed area ratio E₃₁ and the second exposed area ratio E₃₂ may be selected to differ from E₂₁ and E₂₂. In such cases, the greater the difference between E₃₁ and E₃₂, the better.

As described above, the inspection result of the second inspection step is used to correct the first relational expression thereby producing the second relational expression, and the inspection result of the third inspection step is used to correct the second relational expression thereby producing the third relational expression. In this way, each time a new inspection result is obtained, it is used to correct the relational expression derived in the previous relational expression determination step. This makes it possible to compensate for the differences in etching rate or in any other parameter between different types of wafers. Furthermore, this method also can be used to compensate for process variations. (It should be noted that process variations occur over time due to changes in the processing apparatus or in the environment, etc. even if the processing conditions are maintained.) Specifically, a parameter (or property) of products may be inspected, and the inspection result may be used to adjust the processing conditions so as to reduce process variations, thereby reducing variations in products.

Thus, after step 18, each time a different type of wafer is processed and inspected, the inspection result is used to correct the relational expression derived in the previous relational expression determination step. That is, each time a new inspection result is produced by the inspection apparatus 14, the last relational expression is corrected using reference points which are determined in accordance with the last relational expression and a point which represents the produced inspection result. The processing in steps S19 to S25 is identical to the processing in steps S12 to S18, respectively. FIG. 6 is a diagram showing the way in which the i-th relational expression is derived. In step S20, the etching rate V_{calci3} of the next wafer type to be processed is calculated by substituting the mask pattern exposed area ratio Eᵢ₃ of the next wafer type to be processed in the i-th processing step (step S22) into the (i−1)th relational expression derived in the previous relational expression determination step (i.e., V=Vᵢ₋₁(E)). An etching condition is then determined based on the calculated etching rate V_{calci3}(=Vᵢ₋₁(Eᵢ₃)). In the i-th processing step (step S22), the processing apparatus 12 etches a wafer under the determined etching condition. In step S25, the i-th relational expression is derived by means of the least squares method from reference points Pᵢ₁ and Pᵢ₂ on a straight line Lᵢ₋₁ which represents the (i−1)th relational expression and a point Pᵢ₃ which represents the inspection result Vᵢ₃ of the i-th inspection step (step S23). (The coordinates of Pᵢ₃ are (Eᵢ₃, Vᵢ₃).) The i-th relational expression (or equation) is as follows:

Vi(E)=cᵢ+aᵢ×E Equation 5

where cᵢ and aᵢ are given by the following equations:

$$\begin{matrix}{c}_{i} = \frac{{\sum }_{j = 1}^{3} {E}_{ij}^{2} {\sum }_{j = 1}^{3} {V}_{ij} - {\sum }_{j = 1}^{3} {E}_{ij} {V}_{ij} {\sum }_{j = 1}^{3} {E}_{ij}}{3 {\sum }_{j = 1}^{3} {E}_{ij}^{2} - {( {\sum }_{j = 1}^{3} {E}_{ij} )}^{2}} & Equation 6 \\ {a}_{i} = \frac{3 {\sum }_{j = 1}^{3} {E}_{ij} {V}_{ij} - {\sum }_{j = 1}^{3} {E}_{ij} {\sum }_{j = 1}^{3} {V}_{ij}}{3 {\sum }_{j = 1}^{3} {E}_{ij}^{2} - {( {\sum }_{j = 1}^{3} {E}_{ij} )}^{2}} & Equation 7\end{matrix}$$

If, in step S26, it is determined that there is no reason (such as maintenance of the processing apparatus) to stop the iteration of the wafer process (which includes correcting a relational expression), then the (i+1)th processing step, the (i+1)th inspection step, the (i+1)th relational expression determination step, etc. are performed, which are similar to the i-th processing step, the i-th inspection step, the i-th relational expression determination step, respectively. In this way, these steps are repeated until a reason to stop the process comes up in step S26.

It should be noted that if the first exposed area ratio Eᵢ₁ and the second exposed area ratio Eᵢ₂ for deriving the i-th relational expression are selected to be equal to the first exposed area ratio E₍ᵢ₋₁₎₁ and the second exposed area ratio E₍ᵢ₋₁₎₂, respectively, for deriving the (i−1)th relational expression, then it is easy to derive the i-th relational expression (where i is any integer greater than 1). When N types of wafers having mask exposed area ratios Eᵢ₃, Eᵢ₄, . . . E_{iN+2} are processed in the i-th processing step, N types of inspection results Vᵢ₃, Vᵢ₄, . . . , V_{iN+2} are produced in the i-th inspection step. In this case, each summation (Σ) in Equations 6 and 7 must be for j=1, 2, . . . , N+2, instead of j=1, 2, 3. Specifically, Equations 8 and 9 below are used instead of Equation 6 and 7.

$$\begin{matrix}{c}_{i} = \frac{{\sum }_{j = 1}^{N + 2} {E}_{ij}^{2} {\sum }_{j = 1}^{N + 2} {V}_{ij} - {\sum }_{j = 1}^{N + 2} {E}_{ij} {V}_{ij} {\sum }_{j = 1}^{N + 2} {E}_{ij}}{( N + 2 ) {\sum }_{j = 1}^{N + 2} {E}_{ij}^{2} - {( {\sum }_{j = 1}^{N + 2} {E}_{ij} )}^{2}} & Equation 8 \\ {a}_{i} = \frac{( N + 2 ) {\sum }_{j = 1}^{N + 2} {E}_{ij} {V}_{ij} - {\sum }_{j = 1}^{N + 2} {E}_{ij} {\sum }_{j = 1}^{N + 2} {V}_{ij}}{( N + 2 ) {\sum }_{j = 1}^{N + 2} {E}_{ij}^{2} - {( {\sum }_{j = 1}^{N + 2} {E}_{ij} )}^{2}} & Equation 9\end{matrix}$$

Further, when a relational expression is corrected in the manner described above, if there are many inspection results available as a result of many types of wafers having been processed in the last processing step, or if inspection results used to correct the relational expression include significant error, then it may be desirable to limit the degree to which the correction of the relational expression reflects these inspection results. On the other hand, in some cases it may be desirable that the correction significantly reflects the last inspection results. In either case, the reference points and the points representing the inspection results may be weighted and least squares approximation may be used to correct the relational expression.

The wafer processing method and the wafer processing system of the present embodiment make it possible to determine an optimum processing condition (namely, etching rate) for each of a plurality of different types of wafers by using a simple method. Specifically, an appropriate processing condition for each type of wafer can be determined by using a relational expression which quantitatively relates a processing condition (namely, etching rate) of a wafer to its mask pattern exposed area ratio. Further, the wafer processing method and the wafer processing system of the present embodiment make it possible to determine an appropriate processing condition for each of a plurality of different types of wafers by using a relational expression which reflects process variations. Therefore, it is possible to compensate for or reduce process variations over time, as well as to reduce the quality variations between different types of wafers. Further, by using a relational expression it is also possible to determine an optimum processing condition for each type of wafers which have not yet been processed. Thus, the quality variations between different types of wafers can be reduced by setting an optimum processing condition for each type of wafer. Further, since the relational expression is a linear function, it is easy to determine a processing condition for any type of wafer.

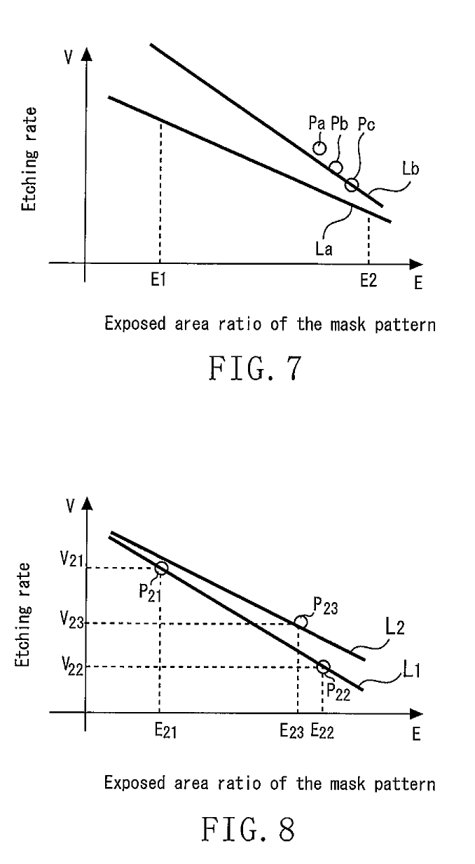

It should be noted that a relational expression may not be accurate if it is derived only from the last inspection results (of a plurality of wafers) without using the relational expression derived in the previous relational expression determination step. This will be described with reference to FIG. 7. FIG. 7 is a diagram showing a straight line representing a comparative relational expression derived only from the last inspection results of a plurality of types of wafers. Specifically, in FIG. 7, a straight line La represents a relational expression derived in the previous relational expression determination step, and a straight line Lb represents a relational expression derived in the current relational expression determination step. The line Lb has been derived only from the last inspection results Pa, Pb, and Pc without using the previous inspection results from which the line La was derived. Since the last inspection results Pa, Pb, and Pc (which represent etching rates) were produced at high mask pattern exposed area ratios, the resulting line Lb is likely to have significant error at low mask pattern exposed area ratios.

In the wafer processing method of the present embodiment, on the other hand, a relational expression is derived from two or more reference points which are determined in accordance with the previous relational expression and a point or points which represent the last inspection results. Therefore, even if the last inspection results are produced only at mask pattern exposed area ratios in a particular range, the reference points determined in accordance with the previous relational expression serve to compensate for such bias in the mask pattern exposed area ratio at which the last inspection results are produced. As a result, it is possible to estimate the etching rates of wafers having different mask pattern exposed area ratios with little error.

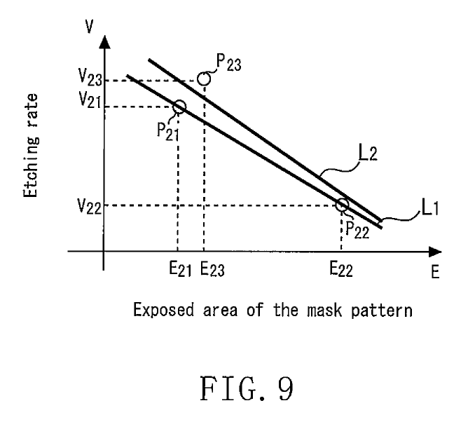

For example, let it be assumed that an inspection result of a type of wafer having a high mask pattern exposed area ratio has been obtained. FIG. 8 is a diagram showing the way in which a relational expression is corrected using the last inspection result of a type of wafer having a high mask pattern exposed area ratio. In this correction, the last inspection result P₂₃ affects the relational expression only slightly at low mask pattern exposed area ratios even though it affects the relational expression significantly at high mask pattern exposed area ratios. Further, let it be assumed that an inspection result of a type of wafer having a low mask pattern exposed area ratio has been obtained. FIG. 9 is a diagram showing the way in which a relational expression is corrected using the last inspection result of a type of wafer having a low mask pattern exposed area ratio. In this correction, the last inspection result P₂₃ affects the relational expression only slightly at high mask pattern exposed area ratios even though it affects the relational expression significantly at low mask pattern exposed area ratios.

In actual wafer processes, it is not always possible to obtain inspection results of wafers whose mask pattern exposed area ratios range widely and evenly from the lowest to highest possible values; that is, only inspection results of types of wafers whose mask pattern exposed area ratios vary over a limited range may be available. Even in such cases, the wafer processing method and the wafer processing system of the present embodiment make it possible to produce a relational expression having little error even at mask pattern exposed area ratios for which no inspection results of wafers are available, since the relational expression is derived from the available inspection results and reference points on a straight line representing the previously derived relational expression. Two reference points may be selected on the line representing the previous relational expression in such a manner that these reference points have a large difference in mask pattern exposed area ratio (e.g., one reference point maybe set at a substantially lowest possible mask pattern exposed area ratio, and the other reference point may be set at a substantially highest possible mask pattern exposed area ratio) in order to significantly reduce the error of the produced relational expression at mask pattern exposed area ratios for which inspection results of wafers are not available.

Although in the present embodiment the initial relational expression is derived from inspection results of a first type wafer and a second type wafer, it is to be understood that the present invention is not limited to this particular method. The first relational expression may be derived from inspection results of any plurality of types of wafers.

Although in the present embodiment the processing steps (including the first processing step, the second processing step, etc.) are etching steps, it is to be understood that the present invention is not limited to etching steps. For example, the present invention may be applied to deposition steps or photolithographic steps while still achieving the above-described advantages. For example, when the invention is applied to deposition steps, the deposition rate on a wafer maybe inspected by the inspection apparatus 14, and the relational express ion determination section 10b may produce a relational expression which relates the deposition rate (or inspection result) on a wafer to its finished dimensions, which are a parameter that depends on the type of wafer. Thus, the inspection result and the parameter that depends on the type of wafer may be replaced with the type of process step to which the present invention is applied.

Although in the present embodiment relational expressions are obtained by the least squares method, it is to be understood that other methods may be used to obtain relational expressions. Further, various alterations may be made to the present embodiment without departing from the features of the present invention.

The present invention makes it possible to determine the optimum processing conditions for different types of wafers by using a simple method.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2012-077084, filed on Mar. 29, 2012 including specification, claims, drawings and summary, on which the Convention priority of the present application is based, are incorporated herein by reference in its entirety.

What is claimed is:

1. A method of processing a wafer, comprising:
a first processing step wherein a processing apparatus applies predetermined processing to a first type wafer and a second type wafer;
a first inspection step wherein an inspection apparatus inspects said wafers after said wafers have been processed in said first processing step;
a step wherein an inspection result acquisition section obtains inspection results of said first inspection step;
a step wherein a relational expression determination section derives a first relational expression from a parameter that depends on the type of wafer and from said inspection results, said first relational expression relating said inspection results to said parameter;
a step wherein a next wafer type identification section identifies a next wafer type to be processed by said processing apparatus;
a step wherein a next processing condition calculation section calculates a next processing condition from said first relational expression, said next processing condition being for said next wafer type to be processed;
a step wherein a notification section notifies said processing apparatus of said next processing condition;
a second processing step wherein said processing apparatus processes a wafer under said next processing condition;
a second inspection step wherein said inspection apparatus inspects said wafer after said wafer has been processed in said second processing step;
a step wherein said inspection result acquisition section obtains an inspection result of said second inspection step;
a step wherein said relational expression determination section produces a second relational expression by correcting said first relational expression using reference points determined in accordance with said first relational expression and a point representing said inspection result of said second inspection step, said reference points and said point being set on a coordinate plane whose horizontal axis represents said parameter and whose vertical axis represents said inspection results; and
a step wherein a wafer is processed under a processing condition calculated from said second relational expression;
wherein each time said inspection apparatus produces a new inspection result, the last relational expression is corrected using reference points which are determined in accordance with said last relational expression and a point which represents said new inspection result.

2. The method according to claim 1, wherein:
said first and second processing steps are etching steps;
said parameter that depends on the type of wafer is the exposed area ratio of mask patterns formed on a wafer; and
said inspection results are etching rates.

3. The method according to claim 1, wherein:
said first relational expression, said second relational expression, and said last relational expression are linear functions; and
the y-intersects and the slopes of said first relational expression, said second relational expression, and said last relational expression are obtained by the least squares method.

4. A wafer processing system comprising:
a processing apparatus for applying predetermined processing to a first type wafer and a second type wafer;
an inspection apparatus for inspecting said wafers after said wafers have been processed by said processing apparatus;
an inspection result acquisition section for obtaining inspection results produced by said inspection apparatus;
a relational expression determination section for deriving a first relational expression from a parameter that depends on the type of wafer and from said inspection results, said first relational expression relating said inspection results to said parameter;
a next wafer type identification section for identifying a next wafer type to be processed by said processing apparatus;
a next processing condition calculation section for calculating a next processing condition from said first relational expression, said next processing condition being for said next wafer type to be processed; and
a notification section for notifying said processing apparatus of said next processing condition;
wherein said processing apparatus processes a wafer under said next processing condition;
wherein said inspection apparatus inspects said wafer after said wafer has been processed under said next processing condition;
wherein said inspection result acquisition section obtains an inspection result of said wafer inspected after said wafer has been processed under said next processing condition;
wherein said relational expression determination section produces a second relational expression by correcting said first relational expression using reference points determined in accordance with said first relational expression and a point representing said inspection result of said wafer inspected after said wafer has been processed under said next processing condition, said reference points and said point being set on a coordinate plane whose horizontal axis represents said parameter and whose vertical axis represents said inspection results;
wherein said processing apparatus processes a wafer under a processing condition calculated from said second relational expression; and
wherein each time said inspection apparatus produces a new inspection result, said relational expression determination section corrects the last relational expression using reference points which are determined in accordance with said last relational expression and a point which represents said new inspection result.
